(19) United States
(12) Patent Application Publication
(10) Pub. No.: US 2026/0340136 A1
(43) Pub. Date: Oct. 29, 2026

(54) BOOTING OF DEVICES FOR SOFTWARE ASSURANCE IN A CLOUD ENVIRONMENT

(71) Applicant: Oracle International Corporation, Redwood Shores, CA (US)

(72) Inventors: Claudio Sasso, Berkshire (GB); Luca Altamura, Dubai (AE); Mohamed Ismail Bari, Berkshire (GB)

(73) Assignee: Oracle International Corporation, Redwood Shores, CA (US)

(21) Appl. No.: 19/191,384

(22) Filed: Apr. 28, 2025

(51) Int. Cl. G06F 21/57

(52) U.S. Cl. CPC G06F 21/575; G06F 2221/034

(57) ABSTRACT

Techniques for booting a device, and using the device for ensuring software assurance in a cloud environment are disclosed. The device is booted, wherein booting the device includes (i) causing to verify an unalterable key hardcoded within a hardware component of the device, (ii) downloading an operating system image, and (iii) loading the operating system image in the device. The device is used to analyze source code stored in a customer tenancy of a cloud environment. An analysis result is caused to be stored in the customer tenancy of the cloud environment, where the analysis result includes one or more snippets of the source code. The analysis result is caused to be extracted from the customer tenancy of the cloud environment to a service tenancy of the cloud environment. In an example, the hardware component includes a plurality of fuses of the device.

### BACKGROUND

A cloud provider provides on-demand, scalable computing resources (e.g., a cloud environment) to its cloud customers. A cloud customer generally desires to run its cloud resources without monitoring, scanning, or other interference by the cloud provider or other cloud customer. Therefore, the cloud provider offers “tenancies” to its cloud customers. A tenancy is an isolated partition within the cloud environment, such that resources in different tenancies are isolated from each other unless explicitly shared. Each tenancy runs a plurality of virtual machine compute instances.

### BRIEF SUMMARY

In various embodiments, a non-transitory computer-readable medium includes instructions that when executed by one or more processors, cause a system comprising the one or more processors to perform operations including: booting a device, wherein booting the device comprises (i) causing to verify a key hardcoded within a hardware component of the device, (ii) downloading an operating system image, and (iii) loading the operating system image; analyzing, by the device, a source code stored in a customer tenancy of a cloud environment; causing to store an analysis result in the customer tenancy of the cloud environment, where the analysis result includes one or more snippets of the source code; and causing extraction of the analysis result from the customer tenancy of the cloud environment to a service tenancy of the cloud environment.

In an example, the operations further include: accessing a plurality of BIOS (basic input/output system) settings of the device; selecting a subset of the BIOS settings; and comparing the selected subset of the BIOS settings with a plurality of target BIOS settings. In an example, the operations further include: detecting a mismatch between the selected subset of the BIOS settings and the plurality of target BIOS settings; and in response to the detected mismatch, causing to present information indicative of the detected mismatch at a user interface. In an example, the operations further include: in response to the detected mismatch, flagging the device as a risk and causing to undertake protective actions against the device. In an example, selecting the subset of the BIOS settings comprises: determining that the plurality of BIOS settings include a first set of persistent settings, and a second set of non-persistent settings, wherein the first set of persistent settings includes the subset of the BIOS settings that are persistent settings; and based at least in part on determining that the subset of the BIOS settings are persistent settings, selecting the subset of the BIOS settings for the comparison. In an example, the operations further include: changing one or more of the BIOS setting, wherein the one or more of the BIOS setting being changed include corresponding one or more keys stored within the one or more of the BIOS setting; and correspondingly changing one or more of the plurality of target BIOS settings. In an example, booting the device further comprises: based at least in part on verifying the unalterable key hardcoded within the hardware component of the device, verifying a second key of BIOS (basic input/output system) settings of the device using the unalterable key; and based at least in part on verifying the second key of BIOS (basic input/output system) settings of the device, verifying a third key of BIOS (basic input/output system) settings of the device using the verified second key. In an example, booting the device further comprises: based at least in part on verifying the third key of the BIOS, (i) downloading the operating system image, and (ii) verifying, using the verified third key, a fourth key that accompanies the operating system image. In an example, wherein booting the device further comprises: verifying, using the verified fourth key, a signature of the operating system image that accompanies the operating system image.

In an example, the key is hardcoded within the hardware component of the device, such that subsequent to the key being hardcoded, the key cannot be changed without damaging the hardware component. In an example, the hardware component comprises a plurality of fuses of the device that can be written or programmed only once. In an example, the source code is for deployment to a plurality of mobile devices. In an example, the device is a small-form-factor device that (i) has no operational Universal Serial Bus (USB) port and/or no wireless connectivity capability, or (ii) has an USB port and/or wireless connectivity capability disabled through BIOS (basic input/output system) settings of the device. In an example, the operations further include: causing to at least temporarily store the analysis result in the device.

In various embodiments, a method comprises: booting a device, wherein booting the device comprises (i) causing to verify key hardcoded within a hardware component of the device, (ii) downloading an operating system image, and (iii) loading the operating system image in the device; analyzing, by the device, a source code stored in a customer tenancy of a cloud environment; causing to store an analysis result in the customer tenancy of the cloud environment, where the analysis result includes one or more snippets of the source code; and causing extraction of the analysis result from the customer tenancy of the cloud environment to a service tenancy of the cloud environment. In an example, the method further comprises: accessing a plurality of BIOS (basic input/output system) settings of the device; selecting a subset of the BIOS settings; and comparing the selected subset of the BIOS settings with a plurality of target BIOS settings. In an example, the method further comprises: detecting a mismatch between the selected subset of the BIOS settings and the plurality of target BIOS settings; and in response to the detected mismatch, (i) causing to present information indicative of the detected mismatch at a user interface, and (ii) flagging the device as a risk and causing to undertake protective actions against the device. In an example, booting the device further comprises: based at least in part on verifying the unalterable key hardcoded within the hardware component of the device, verifying a second key of BIOS (basic input/output system) settings of the device using the unalterable key; based at least in part on verifying the second key of BIOS (basic input/output system) settings of the device, verifying a third key of BIOS (basic input/output system) settings of the device using the verified second key; based at least in part on verifying the third key of the BIOS, (i) downloading the operating system image, and (ii) verifying, using the verified third key, a fourth key that accompanies the operating system image; and verifying, using the verified fourth key, a signature of the operating system image that accompanies the operating system image.

In various embodiments, a system comprises: one or more processors; and one or more non-transitory computer-readable media storing instructions, which, when executed by the system, cause the system to perform a set of actions including: booting a device, wherein booting the device comprises (i) causing to verify a key hardcoded within a hardware component of the device, (ii) downloading an operating system image, and (iii) loading the operating system image; analyzing a source code stored in a customer tenancy of a cloud environment; causing to store an analysis result in the customer tenancy of the cloud environment, where the analysis result includes one or more snippets of the source code; and causing extraction of the analysis result from the customer tenancy of the cloud environment to a service tenancy of the cloud environment. In an example, the actions further include: accessing a plurality of BIOS (basic input/output system) settings of the device; selecting a subset of the BIOS settings; and comparing the selected subset of the BIOS settings with a plurality of target BIOS settings.

In some embodiments, a system comprises one or more processors; and one or more non-transitory computer-readable media storing instructions, which, when executed by the system, cause the system to perform a set of actions including monitoring a plurality of target interactions of a target user with an item providing platform; receiving a plurality of target recommendations for the target user from a recommendation system of the item providing platform; and inferring, using an attack classifier and based on (i) the plurality of target interactions and (ii) the plurality of target recommendations, whether at least a subset of the plurality of target interactions and/or at least a subset of the plurality of target recommendations were used to train the recommendation system, wherein the attack classifier is trained using training data associated with a plurality of autonomous users interacting with the item providing platform. In an example, the item providing platform is one of a video providing platform, an audio providing platform, or a shopping platform.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a setup for software assurance in a cloud environment.

FIG. 2 illustrates a hardware component within a device usable to analyze source code within a customer tenancy of a cloud environment, wherein the hardware component is used to implement a Root of Trust (RoT) element for booting the device.

FIG. 3 illustrates a chain of custody for a boot process of a device that is usable to analyze source code within a customer tenancy of a cloud environment, wherein a hardware component is used to implement a RoT element for booting the device.

FIG. 3A illustrates verification of a chain of keys during a boot process of a device usable to analyze source code within a customer tenancy of a cloud environment.

FIG. 4 illustrates a setup for software assurance in a cloud environment, and for auditing of BIOS settings of a device that is usable to analyze source code within a customer tenancy of the cloud environment.

FIG. 5 illustrates an operation of an auditing service.

FIG. 6 is a flow diagram depicting a method for booting a device that is usable to analyze source code within a customer tenancy of a cloud environment, wherein a hardware component within the device is used to implement a RoT element for booting the device.

FIG. 7 depicts a simplified diagram of a distributed system for implementing certain aspects.

FIG. 8 is a simplified block diagram of one or more components of a system environment by which services provided by one or more components of an embodiment system may be offered as cloud services, in accordance with certain aspects.

FIG. 9 illustrates an example computer system that may be used to implement certain aspects.

### DETAILED DESCRIPTION

Maintaining security of a cloud environment involves controlling access to cloud resources based on permissions specified by respective cloud customers. A cloud customer can grant permissions for accessing cloud resources that it rents, but the cloud customer should not be able to grant permissions for accessing cloud resources rented by other customers. A tenancy is a conceptual bucket that holds cloud resources belonging to a particular cloud customer. An administrator of a tenancy has administrative rights to set access policies for cloud resources in the tenancy; an administrator of a tenancy does not have administrative rights to set access policies for cloud resources in another tenancy. A tenancy of a cloud customer is isolated from another tenancy of another cloud customer. A tenancy of a cloud customer includes a plurality of active cloud resources, such as compute instances that are used to host virtual machines. The cloud provider may also have control on one or more tenancies (e.g., cloud provider tenancies), through which the cloud provider may provide one or more services to the cloud customers.

In an example, a tenancy rented to a cloud customer (also referred to herein as a “cloud customer tenancy”) includes one or more repositories for storing source code of one or more programs. For example, the source code may be of a program that is deployable within a plurality of mobile devices. In one example, the source code may be processed through a build pipeline to generate software packages including binary version of the source code. The software packages including binary version of the source code may then be deployed to a plurality of mobile devices. In another example, the source code represents the software packages including binary version of code that are deployable to a plurality of mobile devices. The scope of this disclosure is not limited to any particular type of source code.

In a typical scenario, a cloud customer renting a tenancy may develop source codes, test, build, and package the source codes, and deploy the source codes to a plurality of mobile devices, without significant intervention, monitoring, and/or control from a provider of the cloud environment or from another third party.

However, in the cloud environment described herein, in the context of software assurance, an additional role of an assurance administrator is added into the picture. The assurance administrator may or may not be the same as the cloud provider. In an example, the assurance administrator acts as a “trusted technology provider” (TTP). It is assumed herein that the assurance administrator is the same as the cloud provider (the provider or owner of the cloud environment), although the teachings of this disclosure are not limited by such assumptions, and the assurance administrator may be different from the cloud provider.

With regard to the subject disclosure, in an example, the assurance administrator has a monitoring role over a manner in which the cloud customer is using the cloud resources. Merely as an example, the assurance administrator may want to monitor the source code, to ensure that the cloud customer is compliant with guidelines mutually agreed between the cloud customer and the assurance administrator. In an example, the assurance administrator may be tasked by a government regulatory agency to monitor the source code, e.g., to ensure that the source code adheres to regulatory guidelines established by the government regulatory agency. As a part of such software assurance, the assurance administrator may want to review and analyze the source code stored within the cloud customer tenancy, and/or review and analyze various logs, messages, reports, etc. generated within the cloud customer tenancy. Detected anomalies or issues may be reported back to the assurance administrator. The assurance administrator processes such anomalies or issues, and may negotiate with the cloud customer to fix the detected anomalies or issues. In an example, if the anomalies or issues indicate significant security risks, the assurance administrator may escalate the anomalies or issues, and in extreme cases, may even report the anomalies or issues to a higher reporting authority (such as a government regulatory agency). Software assurance actions taken by the assurance administrator may be implementation specific, and may vary from one implementation to the next.

In an example, one or more personnel engaged by the assurance administrator may operate one or more devices that are used for analyzing the source code, storing the analysis results within the cloud customer tenancy, and/or subsequently transferring the analysis results from the cloud customer tenancy to a service tenancy of the assurance administrator. In an example, the assurance administrator may not immediately want to share with the cloud customer the actual results data being transferred from the cloud customer tenancy to the assurance administrator tenancy, and may want to maintain “confidentiality of analysis” of the analysis results for at least a short period of time. On the other hand, as the source code is developed by the cloud customer, the cloud customer may prefer to maintain confidentiality of the source code. This is referred to as the cloud customer's desire to maintain “confidentiality of the source code.” Accordingly, in an example, there is a level of lack of trust between the assurance administrator and the cloud customer, and there are conflicting objectives between the goals of the cloud customer and the assurance administrator.

In an example, the analysis of the source code is performed by one or more devices that are located within a dedicated physical facility that is controlled solely by the cloud customer, or jointly by the assurance administrator and the cloud customer, as described below in further detail. For example, the cloud customer may want to have some kind of surveillance within the physical facility, e.g., to prevent or at least reduce chances of leakage of the source code from the physical facility. Devices physically located within the physical facility are operated by personnel of the assurance administrator, and these devices are used to access the source code stored in one or more storage repositories that are within a cloud customer tenancy of the cloud environment. In an example, such devices are small-form-factor devices, and may lack (or has a relatively few number of) external peripheral ports, such as Universal Serial Bus (USB) ports, e.g., to prevent or at least reduce chances of copying of the source code using such ports. For similar reasons, in an example, such devices may lack wireless connectivity capabilities.

In an example, because (i) a device used for such analysis operates from the physical facility that is at least in part under control of the cloud customer and (ii) there is a degree of lack of mutual trust between the cloud customer and the assurance administrator, the assurance administrator undertakes several measures to prevent or reduce chances of tampering of the device by any malicious actor. For example, an OS image of the device is downloaded from a secure location (which may be a storage repository in a secure safe within the physical facility, or may be a storage repository within a service tenancy of the assurance administrator). During the boot process of the device, the device downloads the OS image, and loads the OS image upon verification of an authenticity of the OS image.

In an example, the boot process of the device may be a secure boot process. For example, the secure boot process is based on a Root of Trust (RoT) element, which relies on a physical hardware component within the device. The RoT provides a key element of hardware-based boot integrity, to eliminate or at least reduces chances of unauthorized BIOS boot block modifications. The related keys and policies for the RoT reside in a hardware component (such as a plurality of fuses) of a chip within the device, and hence, are difficult to tamper with. The hardware component may be written, configured, or programmed only once, and once programmed, the programming of the hardware component cannot be changed, as described below in further detail. In an example, the programming of the hardware component may be performed by a manufacturer of the hardware component or a manufacturer of the device. In another example, the programming of the hardware component may be performed by personnel of the assurance administrator, e.g., during a provisioning of the device.

The RoT, by relying on the hardware component, implements a hardware-based static rooting process. After the RoT process is performed, a chain of trust is implemented for bootup of the device, where starting with the RoT, every subsequent sub-process of the boot process is authenticated or verified by a previous sub-process before being executed. For example, the RoT gives control to other keys in the BIOS. The BIOS continues with the secure boot process, and gives control to a boot loading service within the device. The boot loading service checks for keys of the cloud provider. If the keys are correct, the boot loading service acts as a gateway, and downloads the OS image from a storage repository to the device. In an example, the OS image, prior to, during, or subsequent to being downloaded to the device, is authenticated (e.g., by the boot loading service) using the keys of the assurance administrator.

For example, a chain of custody for the boot process of the device is implemented. The chain of custody for the boot process includes a plurality of sub-processes, which includes at least these example sub-processes: (i) RoT initiating a rooting process using keys hardcoded in the hardware component, (ii) the RoT, upon checking the keys, passes control to other keys in the BIOS, (iii) BIOS continues with the secure boot process, and gives control to a boot loading service, and (iv) the boot loading service checks for keys of the assurance administrator, and acts as a gateway to download the OS image. Thus, a chain of keys is verified during the boot process of the device.

Thus, a verification of a chain of keys during a boot process of the device is performed. For example, an initial sub-process in the boot process verifies a key 1 that is hardcoded within the hardware component. Once the key 1 is verified, this key 1 is used to verify a key 2 stored in the BIOS settings of the device, where verification of the key 2 results in initiation of a first sub-process of the boot process. Subsequently, the key 2 is used to verify a key 3, and verification of the key 3 triggers a second sub-process of the boot process. This process continues, culminating with verification of a key N that accompanies the downloaded OS image. Once the key N accompanying the downloaded OS image is verified using a previously verified key (N−1), the OS image is loaded in the device, as described below in further detail.

Once the OS image is loaded in the device, the device is used to access and analyze the source code within the customer tenancy of the cloud environment, as described below in further detail.

In an example, to ensure authenticity of the keys within the BIOS setting of the device, periodic auditing of the BIOS setting of the device is undertaken. In an example an auditing service may be implemented locally (e.g., from a secure device located within the physical facility described above). In another example, the auditing service may be implemented from a service tenancy of the assurance administrator. In any case, the auditing service is controlled by the personnel of the assurance administrator.

In an example, during the auditing process, the BIOS settings of the device are compared to a snapshot of target BIOS settings. Note that some BIOS settings of the device (such as counters, clocks, etc.) may change with time. Accordingly, persistent BIOS settings of the device may be compared, and BIOS settings that are prone to change with time may be ignored during the comparison, as described below in further detail.

If at least the persistent section of the BIOS settings of the device matches with at least the corresponding section of the target BIOS settings, this implies that the BIOS settings of the device were most likely not tampered with by any malicious actor.

However, if at least the persistent section of the BIOS settings of the device does not match with at least the corresponding section of the target BIOS settings, this implies that the BIOS settings of the device may have been tampered with by a malicious actor. Accordingly, the issue is further investigated, the mismatch is indicated in a user interface (UI) of a device accessible to personnel of the assurance administrator, and/or the device is flagged as a risk, so that the personnel of the assurance administrator may undertake protective actions against the device.

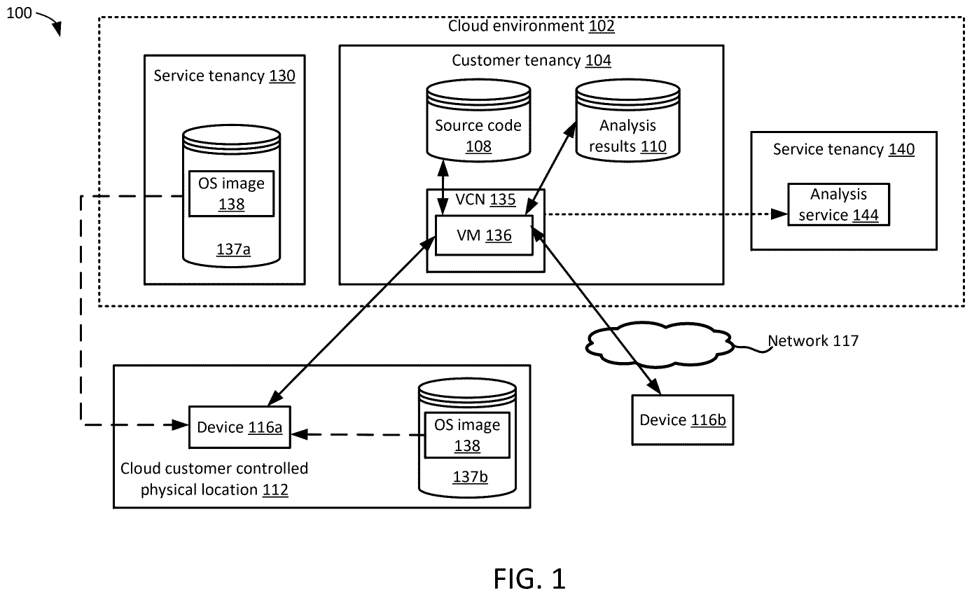

FIG. 1 illustrates a setup 100 for software assurance in a cloud environment 102. The setup 100 includes the cloud environment 102, which provides on-demand, scalable computing resources to its cloud customers. An outline of the cloud environment 102 is illustrated using dotted lines.

The cloud provider provides each cloud customer a “tenancy.” A tenancy is an isolated partition within the cloud environment, such that resources in different tenancies are isolated from each other unless explicitly shared. For example, a customer tenancy 104 is rented out to a cloud customer of the cloud environment 102. The customer tenancy 104 of the cloud customer is isolated from any other tenancy of the cloud environment 102.

The cloud customer to whom the customer tenancy 104 is rented out may use cloud resources of the customer tenancy 104 for any appropriate purpose. In an example, the cloud customer uses the customer tenancy 104 to one or more of develop, test, package, store, and/or deploy source code 108. For example, FIG. 1 illustrates the source code 108 stored in a storage repository within the customer tenancy 104. The source code 108 is developed by the cloud customer, and the cloud customer may own the intellectual property or copyright of the source code 108.

The source code 108 may be any appropriate code for any appropriate program. Merely as an example, the source code 108 may be for a mobile application (“mobile app”) that is to be deployed in a plurality of mobile devices. In another example, the source code 108 may be for a website of the cloud customer.

In one example, the source code 108 may be processed through a build pipeline to generate software packages including binary version of the source code. The software packages including binary version of the source code may then be deployed to a plurality of mobile devices. In another example, the source code 108 represents the software packages including binary version of code that are deployable to a plurality of mobile devices. In any case, the source code 108 represent code that are in any stage of being built in a software package, such as prior to or while being tested, packaged, and/or built in deployable software packages, or the final deployable software packages, for example.

In a typical scenario, a cloud customer renting a customer tenancy may develop a source code, test, build, and package the source code, and deploy the source code to a plurality of mobile devices, without any intervention, supervision, or monitoring role by the provider of the cloud environment 102 or by another third party.

However, in the context of software assurance described in this disclosure, in an example, an additional role of an assurance administrator is added into the picture. The assurance administrator may or may not be the same as the provider of the cloud environment 102 (also referred to as the cloud provider). With regard to the subject invention, the assurance administrator needs to have a role or control over a manner in which the cloud customer is using the cloud resources within the customer tenancy 104. Merely as an example, the assurance administrator may want to monitor and/or analyze the source code 108, to ensure that the source code 108 is compliant with guidelines mutually agreed between the cloud customer and the assurance administrator. Thus, the assurance administrator provides software assurance services to the source code 108. In an example, the assurance administrator may be tasked by a regulatory agency to monitor the source code 108, e.g., to ensure that the source code 108 adheres to regulatory guidelines established by the regulatory agency.

For example, as a part of such software assurance, the assurance administrator may want to review and analyze the source code 108, and/or review and analyze various logs, messages, reports, etc. generated within the cloud customer tenancy 104. Detected anomalies or issues with one or more of the source code 108, one or more cloud resources within the customer tenancy 104, and/or the cloud customer may be reported back to the assurance administrator. For example, detected anomalies or issues may be reported to an analysis service 144 of the assurance administrator, described below in detail. The assurance administrator may process such anomalies or issues, and may negotiate with the cloud customer to fix the detected anomalies or issues. In an example, if the anomalies or issues indicate relatively high level of security risks, the assurance administrator may escalate the anomalies or issues, and may even report the anomalies or issues to a higher reporting authority (such as the regulatory agency). Software assurance actions taken by the assurance administrator may be implementation specific, and may vary from one implementation to the next.

There may be some degree of lack of trust between the assurance administrator and the cloud customer. For example, the assurance administrator may not want to immediately or fully to share with the cloud customer the analysis being performed by the assurance administrator on the source code 108, and may want to maintain “confidentiality of analysis” of the source code 108. On the other hand, the cloud customer may also want to main “confidentiality of the source code 108,” as the source code 108 is developed by the cloud customer, and the cloud customer has the rights over the source code 108. Accordingly, there may be a level of mutual lack of trust between the assurance administrator and the cloud customer.

In an example, personnel of the assurance administrator may perform the above-described monitoring and software assurance of the source code 108 from a physical workspace (such as an office or a building) that is owned and/or operated by the cloud customer, although the ownership may also be joint between the assurance administrator and the cloud customer. The hardware (e.g., computers) used to access the cloud infrastructure may be operated by the assurance administrator personnel, and owned and/or monitored by the assurance administrator and/or the cloud customer. For example, the cloud customer may have some degree of physical access to the hardware.

For example, the personnel of the assurance administrator use device 116a and/or device 116b to monitor and/or analyze the source code 108 within the customer tenancy 104 of the cloud environment 102. The device 116a is within a physical location 112 that is controlled by the cloud customer. The physical location 112 may be a dedicated trust center (DTC) used by the assurance administrator for monitoring and analyzing the source code 108. The physical location 112 may also be monitored by the cloud customer, e.g., to prevent leakage of the source code 108 while the assurance administrator monitors and analyzes the source code 108.

For example, while the personnel of the assurance administrator use the device 116a to monitor and analyze the source code 108, the personnel of the assurance administrator may be under video surveillance and/or under electronic surveillance of the cloud customer. For example, personnel of the cloud customer may have physical access and monitoring capacity to areas where personnel of the assurance administrator are using the device 116a to analyze the source code 108, e.g., to avoid any leaks of the source code 108 from the physical location 112. In an example, such surveillance serves at least in part purposes of the confidentiality of the source code 108. In an example, the physical location 112, including the device 116a may have direct or proprietary connectivity to the customer tenancy 104 (e.g., using private network of the cloud customer, the assurance administrator, and/or the provider of the cloud environment 102), e.g., by bypassing the Internet.

In contrast, the device 116b and its operator (who may be a personnel of the assurance administrator) may be in a remote location relative to the physical location 112. The device 116b and its operator may not be under surveillance by the cloud customer, e.g., during an operation of the device 116b. The device 116b, in an example, accesses the customer tenancy 104 through a public network 117, such as the Internet.

In an example, the assurance administrator personnel, using the devices 116a and/or 116b, may analyze the source code 108, and store analysis results 110 in a storage repository within the customer tenancy 104. For example, personnel engaged by the assurance administrator use various types of analysis techniques on the source code 108 and/or the customer tenancy 104, to identify snippets of the source code 108, and/or associated log files, messages, or other associated data to be egressed from the customer tenancy 104 to a service tenancy 140. Examples of such analysis techniques may include manual code review, testing, static analysis tools, etc.

In an example, the analysis results 110 may include logs, messages, reports, etc. generated within the cloud customer tenancy 104, and/or snippets or sections of the source code 108. In an example, the analysis results 110 may be egressed from the customer tenancy 104 to the analysis service 144 pf the service tenancy 140 for subsequent analysis and testing. For example, upon completion of the analysis of the source code 108, the device 116a may cause the analysis results 110 to be transmitted from the customer tenancy 104 to the service tenancy 140. This disclosure is not limited to any specific type of analysis being performed on resources within the customer tenancy 104 and/or the source code 108, nor is limited to any specific type of analysis results 110.

Because the device 116a is under some degree of control of the cloud customer (e.g., due to it being located within the customer controlled physical location 112) during its operation while the device 116b is not, in an example, the device 116a may have more freedom in performing the analysis of the source code 108 than the device 116b. For example, restrictions imposed by the cloud customer on the device 116a to analyze the source code 108 may be less severe than those imposed on the device 116b. Merely as an example, the device 116a is allowed to analyze the source code, and copy snippets of the source code 108 to the analysis results 110. In contrast, while the device 116b is allowed to analyze the source code, and the device 116b may not be allowed to copy snippets of the source code 108 (or allowed to copy of a limited amount of such snippets) to the analysis results 110.

In an example, once the analysis results 110 are stored in the storage repository within the customer tenancy 104, the analysis results 110 may be transmitted to an analysis service 144 within a service tenancy 140. In an example, the service tenancy 140 may be maintained and controlled by the assurance administrator. In an example in which the assurance administrator and the provider of the cloud environment 102 are the same, the service tenancy 140 may be maintained and controlled by the provider of the cloud environment 102. Extraction of the analysis results 110 from the customer tenancy 104 to the service tenancy 140 is described in a co-pending U.S. patent application Ser. No. 18/828,916, filed on Sep. 9, 2024, which is incorporated in its entirety herein.

In an example, when accessing the customer tenancy 104, the assurance administrator personnel may use the device 116a (or the device 116b) to access a virtual machine (VM) 136 within a virtual cloud network (VCN) 135 in the customer tenancy 104. A VCN covers one or more classless inter-domain routing (CIDR) blocks. Cloud resources within the VCN can communicate with each other through a private network path using IP addresses within the CIDR blocks associated with the VCN. A VCN has comprises one or more subnets. Subnets are logical divisions of a VCN. One or more subnets may be created within a VCN. Each subnet has a range of non-overlapping IP addresses. CIDR blocks determine this range of addresses. Each subnet hosts a plurality of compute instances. A compute instance may be used to host a virtual machine, such as the VM 136.

In an example, the device 116a accesses the source code 108 through the VM 136. In an example, the device 116a accesses the source code 108 directly (e.g., by bypassing the VM 136).

In an example, the VCN 135 may be an analysis VCN, e.g., as the VCN may be used to monitor and/or analyze activities of the tenancy 104 of the cloud customer. The assurance administrator may have some degree of control within this VCN 135, although the VCN 135 is within the customer tenancy 104 on which the cloud customer has some degree of control. In an example, access to the source code 108 of the cloud customer tenancy 104 is through the VCN 135 controlled at least in part by the assurance administrator, which ensures that the access to the source code 108 is legitimate and properly documented, thereby avoiding or at least reducing chances of unauthorized access to the source code 108.

As also described above, in an example, the connection between the device 116a and the VCN 135 within the cloud customer tenancy 104 is through a proprietary network of the cloud provider and/or the cloud customer, and may bypass a public network, such as the Internet. This ensures a secure connection between the device 116a and the storage repository storing the source code 108. In another example, at least a part of the connections may be through the Internet.

As described above, the device 116a is within the customer controlled physical location 112. As also described above, there may be some degree of lack of trust between the assurance administrator and the cloud customer. Accordingly, to ensure a secured environment, the device 116a is selected to have relatively fewer number or zero number of input/output ports or peripheral ports. This, for example, prevents or reduces possibility of an unauthorized personnel maliciously copying data (such as the source code 108, or snippets of the source code 108) from the device 116a using, for example, a Universal Serial Bus (USB) port, or a Bluetooth® connection of the device 116a. Accordingly, in an example, the device 116a may lack any USB ports, or have a relatively fewer number (such as at most one or at most two) of USB ports. In another example, all USB ports of the device 116a may be disabled or deactivated.

Similarly, in an example, the device 116a may not have a Bluetooth® connection capability, or a Wi-Fi connection capability. For example, any network connection from the device 116a may be through a wired connection, such as using an Ethernet port of the device 116a. In an example, the device 116a may not have any operational USB port and/or may not have any wireless connectivity capability.

Thus, in an example, a small-form-factor computer may be used for the device 116a. An example of a small-form-factor computer device that can be used for the device 116a is a Next Unit of Computing (NUC)®, which is a small-form-factor computer by Intel®, although other types of small-form-factor computer may also be used.

In an example, a service tenancy 130 of the cloud environment 102 is maintained and controlled by the assurance administrator. In an example in which the assurance administrator and the provider of the cloud environment 102 are the same, the service tenancy 140 is maintained and controlled by the provider of the cloud environment 102.

In an example, during startup of the device 116a, the device 116a may download an operating system (OS) image 138, verify a signature of the OS image 138, and load the OS image 138 for startup of the device 116a. Thus, the device 116a may not have an OS stored therewithin, and use the downloaded OS image 138. The OS image 138 may be for any appropriate type and/or version of an OS.

In an example, because (i) the device is within the cloud customer controlled physical location 112 and (ii) there is a degree of lack of trust between the cloud customer and the assurance administrator, loading the OS image 138 from a remote source (e.g., instead of storing the OS within the device 116a) may prevent or at least reduce possibilities of any malicious tampering of the OS of the device 116a by any unauthorized party.

In an example, the OS image 138 is loaded to the device 116a from an appropriate storage repository 137a or 137b, which may be in the service tenancy 130 or in a secure location within the cloud customer controlled physical location 112. In one example, the storage repository 137a storing the OS image 138 is within the service tenancy 130 controlled by the assurance administrator. In another example, the storage repository 137b storing the OS image 138 is in a secure location or secure safe within the cloud customer controlled physical location 112, where the secure safe is physically and/or electronically controlled by the assurance administrator, such that the cloud customer may not have physical and/or electronic access to the storage repository 137b. In an example, the storage repository 137b may be in a device located physically within the cloud customer controlled physical location 112, and controlled by the personnel of the assurance administrator.

In an example, because (i) the device 116a is within the cloud customer controlled physical location 112 and (ii) there is some degree of lack of trust between the cloud customer and the assurance administrator, the assurance administrator may want to ensure that the device 116a, including a booting of the device 116a, may not be tampered with. Thus, the assurance administrator may want to ensure that the device 116a, which is used for such secure monitoring of cloud resources of the cloud customer tenancy 104, is secure, and free of any tampering.

In an example and as described below in further detail, to ensure secure operation of the device, (i) a secure boot process for the device 116a is implemented, and/or (ii) periodic or aperiodic auditing of the BIOS (basic input/output system) settings are undertaken. Such actions may ensure that the boot process and the BIOS of the device 116a remain secure.

In an example, a secure boot process is implemented for the device 116a. The secure boot process is described with respect to device 116a, and may be applicable to the device 116b as well, in an example.

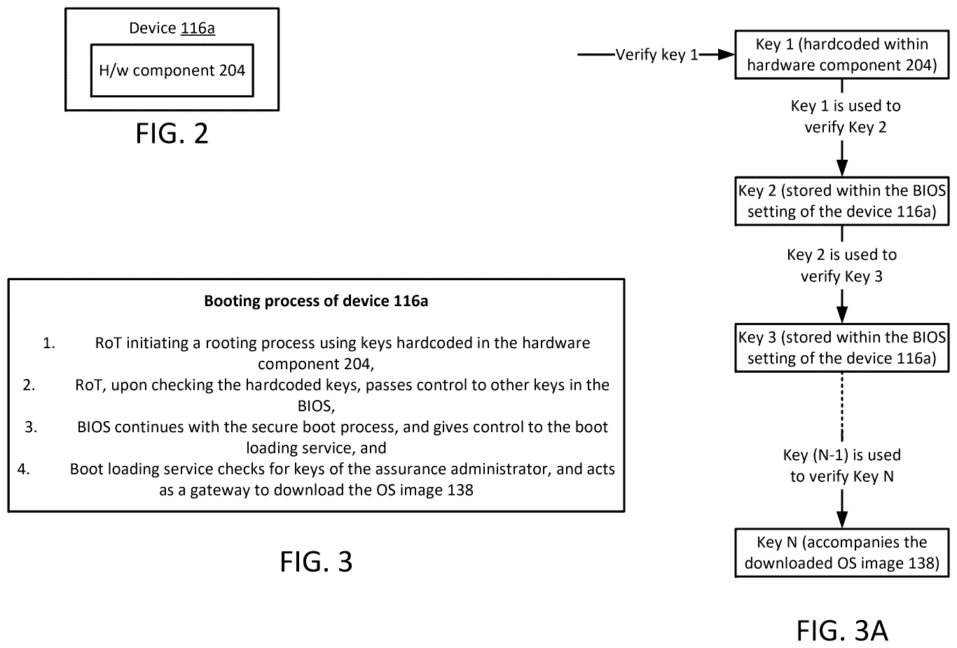

The secure boot process is based on a Root of Trust (RoT) element, which relies on a physical hardware component within the device 116a. FIG. 2 illustrates a hardware component 204 within a device 116a usable to analyze source code 108 within a customer tenancy 104 of a cloud environment 102, wherein the hardware component 204 is used to implement a Root of Trust (RoT) element for booting the device 116a.

For example, a hardware shield below the operating system (OS) of the device 116a is used for the RoT. The RoT provides a key element of hardware-based boot integrity, to eliminate or at least reduces chances of unauthorized BIOS boot block modifications. The related keys and policies for the RoT reside in fuses of a chip within the device 116a, and hence, are difficult to tamper with. The hardware component 204 may be written, configured, or programmed only once, and once programmed, the programming of the hardware component 204 cannot be changed. Thus, the hardware component 204, once programmed, acts as a read only memory.

In an example, the programming of the hardware component 204 may be performed by a manufacturer of the hardware component 204. In another example, the programming of the hardware component 204 may be performed by personnel of the assurance administrator. In an example, the programming of the hardware component 204 involves selectively modifying one or more elements of a plurality of elements (such as blowing one or more fuses of a plurality of fuses) of the hardware component 204. In an example, such modification is irreversible, unalterable, and/or permanent, such that once programmed, such programming cannot be changed without damaging the hardware component 204.

The hardware component 204 is representative of any appropriate hardware component in which the related keys and policies for the RoT reside. For example, the hardware component 204 is programmed or hardcoded to store the related keys and policies for the RoT. The programming of the hardware component 204 may be performed at a transistor level or a fuse level, as described above. Thus, once the hardware component 204 is programmed, the related keys and policies for the RoT stored within the hardware component 204 cannot be modified.

Thus, when booting, the boot integrity is unalterable since it is anchored in the hardware component 204, such as one or more hardware fuses. Thus, the secure boot process for the device 116a is rooted or relies on keys permanently programmed or hardcoded (e.g., using the hardware component 204) within a chip of the device 116.

The RoT, by relying on the hardware component 204, implements a hardware-based static rooting process. After the RoT process is performed, a chain of trust is implemented for bootup of the device 116a, where starting with the RoT, every subsequent sub-process is authenticated or verified by a previous sub-process before being executed.

For example, the RoT gives control to other keys in the BIOS. The BIOS continues with the secure boot process, and gives control to a boot loading service within the device 116a. The boot loading service checks for keys of the cloud provider.

If the keys are correct, then the boot loading service acts as a gateway, and downloads the OS image 138 from a storage repository 137a or 137b, and verifies a signature of the OS image 138. In an example, OS image 138, prior to, during, or subsequent to being downloaded to the device 116a from the service tenancy 130, is authenticated (e.g., by the boot loading service) using the keys of the assurance administrator. For example, to ensure that the correct OS image 138 is downloaded, the OS image 138 comes with a pre-agreed key of a key pair, where a complimentary key of the key paid is within the device 116. While or after the OS image 138 is downloaded, the boot loading service authenticates the key of the OS image 138, using another key stored within the device 116.

FIG. 3 illustrates a chain of custody for a boot process of a device 116a that is usable to analyze source code 108 within a customer tenancy 104 of a cloud environment 102, wherein the hardware component 204 is used to implement a Root of Trust (RoT) element for booting the device 116a.

The chain of custody for the boot process includes a plurality of sub-processes, which includes at least these sub-processes (also see FIG. 3): (i) RoT initiating a rooting process using keys hardcoded in the hardware component 204, where the keys can be programmed only once in the fuses or transistor of the chip, and cannot be reprogrammed, (ii) the RoT, upon checking the keys, passes control to other keys in the BIOS, (iii) BIOS continues with the secure boot process, and gives control to a boot loading service, and (iv) the boot loading service checks for keys of the assurance administrator, and acts as a gateway to download the OS image 138.

Thus, a chain of keys is verified during the boot process of the device 116a. FIG. 3A illustrates verification of a chain of keys during a boot process of the device 116a, where each sub-process in the boot process verifies that an immediate next sub-process is legitimate. For example, the initial sub-process in the boot process verifies a key 1 that is hardcoded within the hardware component 204. Once the key 1 is verified, this key 1 is used to verify a key 2 stored in the BIOS settings of the device 116a, where verification of the key 2 results in initiation of a first sub-process of the boot process. Subsequently, the key 2 is used to verify a key 3, and verification of the key 3 triggers a second sub-process of the boot process.

This process continues, culminating with verification of a key N that accompanies the downloaded OS image 138. Once the key N accompanying the downloaded OS image 138 is verified by key (N−1), the OS image is loaded in the device 116a.

Thus, the key 1 hardcoded within the hardware component 204 initiates a chain of trust process, which eventually results in authentication of the downloaded OS image 138. Because the key 1 is hardcoded within the hardware component 204, this key is unalterable or tamperproof, thereby resulting in a tamperproof verification of the chain of keys illustrated in FIG. 3A. Accordingly, the device 116a is certain that the downloaded OS image 138 is an authentic OS image.

Once the OS image 138 is loaded in the device 116a, the device 116a is used to access the source code 108, as described above in further detail. For example, the source code 108 within the customer tenancy 104 is accessed by the device 116a through the VCN 135 that is at least in part controlled by the assurance administrator. The device 116a is used to analyze the source code 108 in the customer tenancy 104. The analysis results 110 are initially stored in the customer tenancy 104, and eventually extracted to the service tenancy 140.

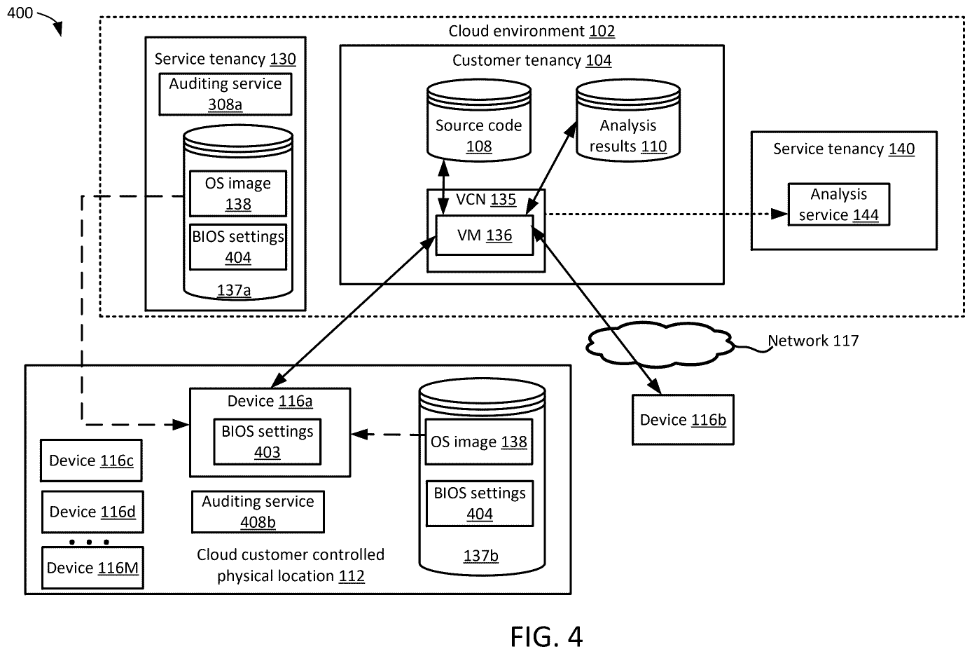

FIG. 4 illustrates a setup 400 for software assurance in a cloud environment 102, and for auditing of BIOS settings within a device 116a that is usable to analyze source code 108 within the customer tenancy 104 of the cloud environment 102. The setup 400 of FIG. 4 is at least in part similar to the setup 100 of FIG. 1. For example, the setup 400 of FIG. 4 includes components illustrated in the setup 100 of FIG. 1. Additionally, the setup 400 of FIG. 4 includes an auditing service 408.

In an example, the auditing service 408 can be configured as a cloud-based auditing service 408a being executed from the service tenancy 130. In another example, the auditing service 408 can be configured as a local auditing service 408b being executed from the cloud customer controlled physical location 112.

In an example where the auditing service 408 is implemented as the local auditing service 408b, the auditing service 408b may execute in a device that is (i) located within the physical location 112 and (ii) controlled by personnel of the assurance administrator. In an example, such a device executes the auditing service 408b, may also include the storage repository 137b described above.

Also, illustrated in the setup 400 of FIG. 4 are additional devices 116c, 116d, . . . , 116M, where one or more of the devices 116a, 116c, . . . , 116M are used to analyze the source code 108. The discussion with respect to the device 116a also applies to one or more (such as all) of the devices 116c, . . . , 116M.

The device 116a includes a plurality of BIOS settings 403. The BIOS settings 403 include configuration parameters that control a manner in which the hardware of the device 116a interacts with its OS and one or more other software, and/or configuration parameters that control the bootup process of the device 116a. Examples of the BIOS settings 403 include one or more of a boot device priority (e.g., an order in which the device 116a searches for a boot device and boot up), settings associated with power management, settings associated with password and key management, and/or the like. Similar to the BIOS settings of the device 116a, the devices 116c, . . . , 116M also have similar BIOS settings.

In an example, the auditing service 408 (which can be any of the auditing services 408a or 408b) audits the BIOS settings of the devices 116a, 116c, . . . , 116M. For example, the auditing service 408 has access to a target BIOS settings 404. The target BIOS settings 404 may be stored within any of the cloud-based storage repository 137a (within the service tenancy 130) or the local storage repository 137b (which is a secure storage repository within a secure safe in the cloud customer controlled physical location 112, where the local storage repository 137b is controlled by the assurance administrator).

In an example, the auditing service 408 compares the BIOS settings 403 of the device 116a with the target BIOS settings 404, e.g., to ensure that at least a section of the BIOS settings 403 matches with at least a corresponding section of the target BIOS settings 404. If at least the section of the BIOS settings 403 matches with at least the corresponding section of the target BIOS settings 404, this implies that the BIOS settings 403 were not tampered with by any malicious actor. However, if at least the section of the BIOS settings 403 does not match with at least the corresponding section of the target BIOS settings 404, this implies that the BIOS settings 403 may have been tampered with by a malicious actor. Accordingly, the issue is further investigated, and the mismatch is indicated in a user interface (UI) of a device accessible to personnel of the assurance administrator.

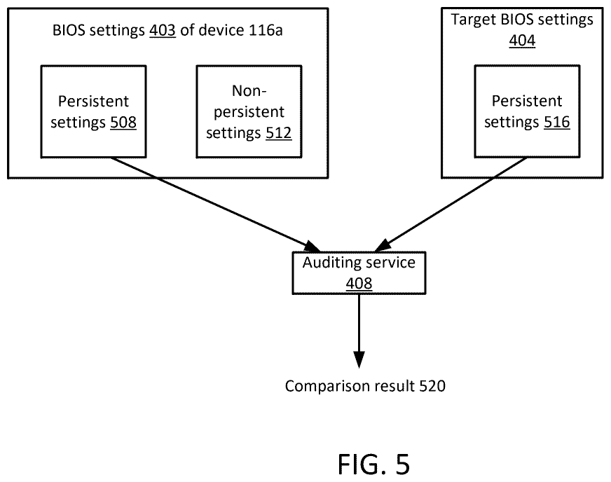

FIG. 5 illustrates an operation of the auditing service 408. As illustrated in FIG. 5, the BIOS settings 403 have two types of settings: (i) persistent settings 508 that usually do not change with time (e.g., unless the BIOS settings are updated by personnel of the assurance administrator), and (ii) non-persistent settings 512 that may change with time. Examples of non-persistent settings 512 may include one or more of a clock, a time and/or date stamp, a counter, etc. Because the non-persistent settings 512 are time variant, the non-persistent settings 512 are not compared by the auditing service 408.

The auditing service 408 compares the persistent settings 508 of the BIOS settings 403 with a corresponding persistent settings 516 of the target BIOS settings 404, and outputs a comparison result 520.

If the comparison result 520 indicates a match between (i) the persistent settings 508 of the BIOS settings 403 of device 116a and (ii) the persistent settings 516 of the target BIOS settings 404, this implies that the BIOS settings 403 were not tampered with by any malicious actor. However, if the comparison result 520 indicates any mismatch between (i) the persistent settings 508 of the BIOS settings 403 of device 116a and (ii) the persistent settings 516 of the target BIOS settings 404, this implies that the BIOS settings 403 may have been tampered with by a malicious actor. Accordingly, the mismatch is indicated through a UI of a device accessible to personnel of the assurance administrator, to cause the personnel of the assurance administrator to take corrective actions and further investigate the issue. For example, the auditing service 408 may, in response to the detected mismatch, flag the device 116a as a risk and cause personnel of the assurance administrator to undertake protective actions against the device 116a.

In an example, the auditing operation performed by the auditing service 408 (such as the comparison operation between the target BIOS settings 404 and the BIOS setting 403 of the device 116) is performed in a random or pseudorandom manner, such that there may not be an advance notice of the auditing process. For example, the auditing service 408 may perform the auditing of the devices 116a, 116c, . . . , 116M in a random order, and/or at periodic or aperiodic intervals. Such randomness in the audit process may further decrease chances of any targeted tampering of the BIOS settings of one or more of these devices by one or more threat actors.

In an example, the keys 2, . . . , N illustrated in FIG. 4 may be periodically or intermittently changed or rotated (note that key 1 hardcoded within hardware component 204 cannot be changed). In an example, based on such change in the cryptographic keys, the BIOS settings 403 within the device 116a, as well as the target BIOS settings 404, may be correspondingly changed.

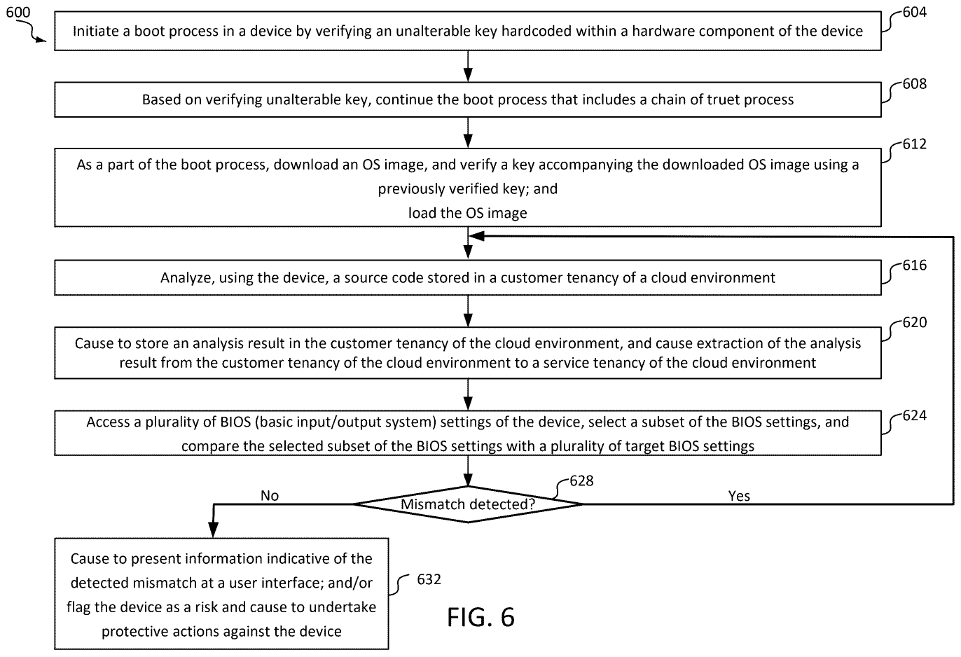

FIG. 6 is a flow diagram depicting a method 600 for booting a device that is usable to analyze source code within a customer tenancy of a cloud environment, wherein a hardware component within the device is used to implement a RoT element for booting the device.

At 604, a boot process to boot the device is initiated. For example, an unalterable key hardcoded within a hardware component of the device is verified (e.g., by a booting service with the device). Any change in the unalterable key may be detected by the booting service. Thus, the boot process proceeds if the unalterable key is verified.

At 608, based on verifying the unalterable key, the boot process is continued, which includes a chain of trust process. For example, as illustrated in FIG. 3A, a chain of keys is verified during the boot process of the device 116a, where each sub-process in the boot process verifies that an immediate next sub-process is legitimate. For example, upon verification of a key, a corresponding sub-process of the boot process is executed. For example, an initial sub-process in the boot process verifies a key 1 that is hardcoded within the hardware component 204. Once the key 1 is verified, this key 1 is used to verify a key 2 stored in the BIOS settings of the device 116a, where verification of the key 2 results in initiation of a first sub-process of the boot process. Subsequently, the key 2 is used to verify a key 3, and verification of the key 3 triggers a second sub-process of the boot process, and so on.

At 612, as a part of the boot process, (i) an OS image is downloaded, (ii) a key accompanying the downloaded OS image is verified using a previously verified key, and (iii) upon verification of the key accompanying the downloaded OS image, the downloaded OS image is loaded in the device, e.g., as described above with respect to FIG. 3A.

At 616, using the device, a source code stored in a customer tenancy of a cloud environment is analyzed. For example, the device 116a accesses the source code 108 within the cloud customer tenancy 104, and analyzes the source code 108.

At 620, an analysis result is caused to be stored in the customer tenancy of the cloud environment, and extraction of the analysis result from the customer tenancy of the cloud environment to a service tenancy of the cloud environment is caused. For example, the device 116a causes the analysis results 110 to be initially stored within the customer tenancy 104, and then transferred to the analysis service 144 of the service tenancy 140.

At 624, (i) a plurality of BIOS settings of the device is accessed, (ii) a subset of the BIOS settings is selected, and (iii) the selected subset of the BIOS settings is compared with a plurality of target BIOS settings. For example, the auditing service 408 thus performs an audit of the BIOS settings 403 of the device 116a.

At 628, a determination is made (e.g., by the auditing service 408) as to whether there is a match between the selected subset of the BIOS settings and the plurality of target BIOS settings.

If there is a match (e.g., “Yes” at 628), this implies that the BIOS settings 403 were not tampered with by any malicious actor. Accordingly, the method 600 loops back to 616, where the device 116a continues analyzing the source code.

If there is a mismatch (e.g., “No” at 628), this implies that the BIOS settings 403 may possibly be tampered with by a malicious actor. Accordingly, the method 600 proceeds from 628 to 632, where the auditing service causes to present information indicative of the detected mismatch at a user interface of the device or another device accessible to personnel of the assurance administrator, and/or otherwise flags the device as a risk and causes to undertake protective actions against the device.

### Computer System Architecture

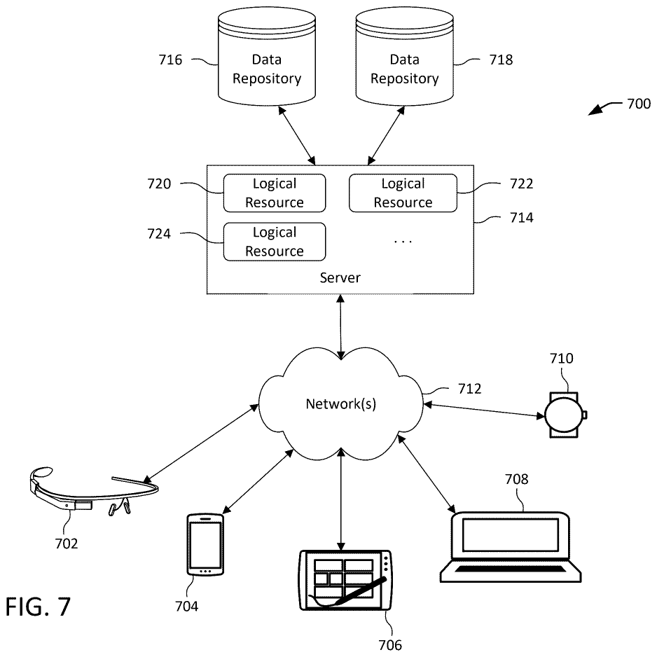

FIG. 7 depicts a simplified diagram of a distributed system 700 for implementing an embodiment. In the illustrated embodiment, distributed system 700 includes one or more client computing devices 702, 704, 706, 708, and/or 710 coupled to a server 714 via one or more communication networks 712. Clients computing devices 702, 704, 706, 708, and/or 710 may be configured to execute one or more applications.

In various aspects, server 714 may be adapted to run one or more services or software applications that enable techniques for booting a device that is usable to analyze source code within a customer tenancy of a cloud environment, wherein a hardware component within the device is used to implement a RoT element for booting the device.

In certain aspects, server 714 may also provide other services or software applications that can include non-virtual and virtual environments. In some aspects, these services may be offered as web-based or cloud services, such as under a Software as a Service (SaaS) model to the users of client computing devices 702, 704, 706, 708, and/or 710. Users operating client computing devices 702, 704, 706, 708, and/or 710 may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various different system configurations are possible, which may be different from distributed system 700. The embodiment shown in FIG. 7 is thus one example of a distributed system for implementing an embodiment system and is not intended to be limiting.

Users may use client computing devices 702, 704, 706, 708, and/or 710 for techniques for booting a device that is usable to analyze source code within a customer tenancy of a cloud environment, wherein a hardware component within the device is used to implement a RoT element for booting the device, in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 712 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 712 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708, and/or 710. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708, and/or 710.

Distributed system 700 may also include one or more data repositories 716, 718. These data repositories may be used to store data and other information in certain aspects. For example, one or more of the data repositories 716, 718 may be used to store information for techniques for booting a device that is usable to analyze source code within a customer tenancy of a cloud environment, wherein a hardware component within the device is used to implement a RoT element for booting the device. Data repositories 716, 718 may reside in a variety of locations. For example, a data repository used by server 714 may be local to server 714 or may be remote from server 714 and in communication with server 714 via a network-based or dedicated connection. Data repositories 716, 718 may be of different types. In certain aspects, a data repository used by server 714 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 716, 718 may also be used by applications to store application data. The data repositories used by applications may be of different types such as, for example, a key-value store repository, an object store repository, or a general storage repository supported by a file system.

In one embodiment, server 714 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

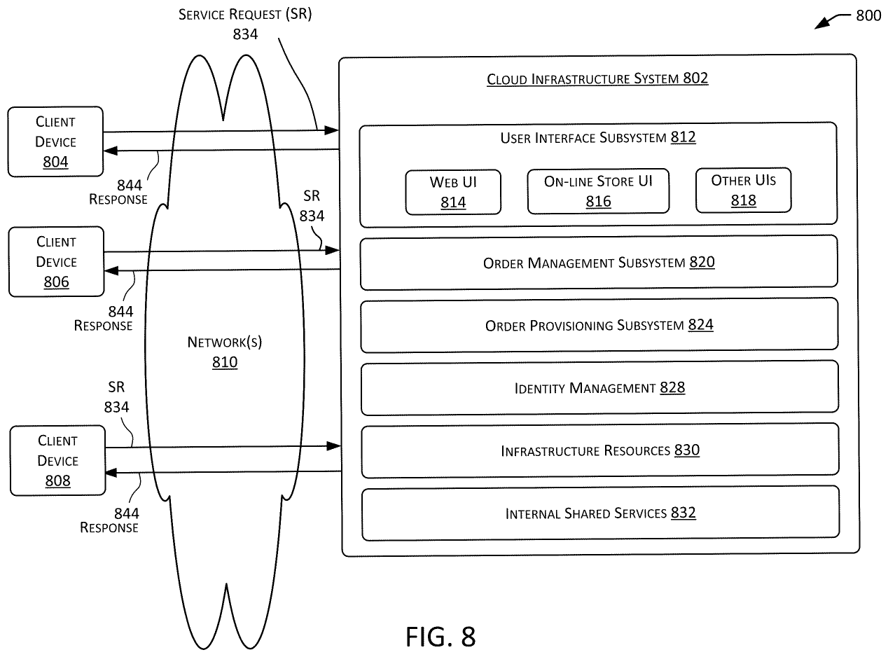

FIG. 8 is a simplified block diagram of a cloud-based system environment in which a device is booted, where the device is usable to analyze source code within a customer tenancy of a cloud environment, wherein a hardware component within the device is used to implement a RoT element for booting the device, in accordance with certain aspects. In the embodiment depicted in FIG. 8, cloud infrastructure system 802 may provide one or more cloud services that may be requested by users using one or more client computing devices 804, 806, and 808. Cloud infrastructure system 802 may comprise one or more computers and/or servers that may include those described above for server 714. The computers in cloud infrastructure system 802 may be organized as general purpose computers, specialized server computers, server farms, server clusters, or any other appropriate arrangement and/or combination.

Network(s) 810 may facilitate communication and exchange of data between clients 804, 806, and 808 and cloud infrastructure system 802. Network(s) 810 may include one or more networks. The networks may be of the same or different types. Network(s) 810 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client computing devices, any number of client computing devices may be supported in alternative aspects.

The term cloud service is generally used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 810 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 802. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third party cloud services provider and the cloud services are offered to any general public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 802 and the services provided may be shared by several organizations in a related community. Various other models such as hybrids of the above mentioned models may also be used.

Client computing devices 804, 806, and 808 may be of different types (such as devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may itself internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various different interfaces such as a web interface 814, an online store interface 816 where cloud services provided by cloud infrastructure system 802 are advertised and are purchasable by a consumer, and other interfaces 818. For example, a tenant may, using a client device, request (service request 834) one or more services provided by cloud infrastructure system 802 using one or more of interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to. For example, a tenant may place a subscription order for a chatbot related service offered by cloud infrastructure system 802. As part of the order, the client may provide information identifying the input (e.g. utterances).

In certain aspects, such as the embodiment depicted in FIG. 8, cloud infrastructure system 802 may comprise an order management subsystem (OMS) 820 that is configured to process the new order. As part of this processing, OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the order provisioning subsystem (OPS) 824 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 802 may send a response or notification 844 to the requesting tenant to indicate when the requested service is now ready for use. In some instances, information (e.g., a link) may be sent to the tenant that enables the tenant to start using and availing the benefits of the requested services.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including possibly proprietary information. In certain aspects, cloud infrastructure system 802 comprises an identity management subsystem (IMS) 828 that is configured to manage tenant's information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

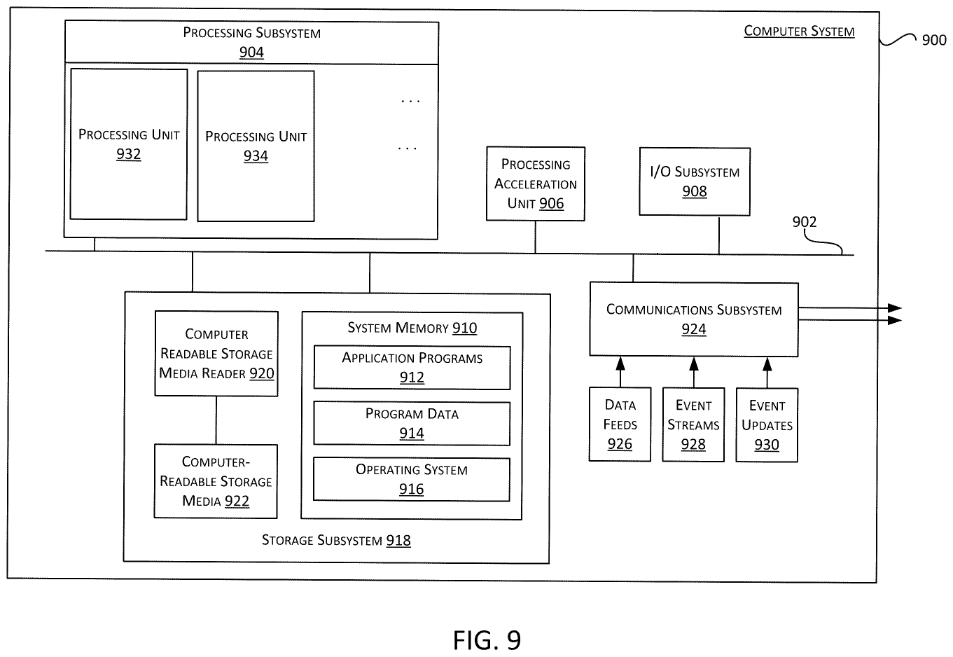

FIG. 9 illustrates an exemplary computer system 900 that may be used to implement certain aspects. As shown in FIG. 9, computer system 900 includes various subsystems including a processing subsystem 904 that communicates with a number of other subsystems via a bus subsystem 902. These other subsystems may include a processing acceleration unit 906, an I/O subsystem 908, a storage subsystem 918, and a communications subsystem 924. Storage subsystem 918 may include non-transitory computer-readable storage media including storage media 922 and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all of the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer readable storage media 922. In various aspects, the processing units can execute a variety of programs or code instructions and can maintain multiple concurrently executing programs or processes. At any given time, some or all of the program code to be executed can be resident in system memory 910 and/or on computer-readable storage media 922 including potentially on one or more storage devices. Through suitable programming, processing subsystem 904 can provide various functionalities described above. In instances where computer system 900 is executing one or more virtual machines, one or more processing units may be allocated to each virtual machine.

In certain aspects, a processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. Reader 920 may receive and be configured to read data from a memory device such as a disk, a flash drive, etc.

In certain aspects, computer system 900 may support virtualization technologies, including but not limited to virtualization of processing and memory resources. For example, computer system 900 may provide support for executing one or more virtual machines. In certain aspects, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, the communications subsystem may be used to transmit a response to a user regarding the inquiry for a chatbot.

Communications subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 924 can provide wired network connectivity (e.g., Ethernet) in addition to or instead of a wireless interface.

Communications subsystem 924 can receive and transmit data in various forms. For example, in some aspects, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system comprising the one or more processors to perform operations including:
booting a device, wherein booting the device comprises (i) causing to verify a key hardcoded within a hardware component of the device, (ii) downloading an operating system image, and (iii) loading the operating system image;
analyzing, by the device, a source code stored in a customer tenancy of a cloud environment;
causing to store an analysis result in the customer tenancy of the cloud environment, where the analysis result includes one or more snippets of the source code; and
causing extraction of the analysis result from the customer tenancy of the cloud environment to a service tenancy of the cloud environment.

2. The non-transitory computer-readable medium of claim 1, wherein the operations further include:
accessing a plurality of BIOS (basic input/output system) settings of the device;
selecting a subset of the BIOS settings; and
comparing the selected subset of the BIOS settings with a plurality of target BIOS settings.

3. The non-transitory computer-readable medium of claim 2, wherein the operations further include:
detecting a mismatch between the selected subset of the BIOS settings and the plurality of target BIOS settings; and
in response to the detected mismatch, causing to present information indicative of the detected mismatch at a user interface.

4. The non-transitory computer-readable medium of claim 3, wherein the operations further include:
in response to the detected mismatch, flagging the device as a risk and causing to undertake protective actions against the device.

5. The non-transitory computer-readable medium of claim 2, wherein selecting the subset of the BIOS settings comprises:
determining that the plurality of BIOS settings include a first set of persistent settings, and a second set of non-persistent settings, wherein the first set of persistent settings includes the subset of the BIOS settings that are persistent settings; and
based at least in part on determining that the subset of the BIOS settings are persistent settings, selecting the subset of the BIOS settings for the comparison.

6. The non-transitory computer-readable medium of claim 3, wherein the operations further include:
changing one or more of the BIOS setting, wherein the one or more of the BIOS setting being changed include corresponding one or more keys stored within the one or more of the BIOS setting; and
correspondingly changing one or more of the plurality of target BIOS settings.

7. The non-transitory computer-readable medium of claim 1, wherein booting the device further comprises:
based at least in part on verifying the unalterable key hardcoded within the hardware component of the device, verifying a second key of BIOS (basic input/output system) settings of the device using the unalterable key; and
based at least in part on verifying the second key of BIOS (basic input/output system) settings of the device, verifying a third key of BIOS (basic input/output system) settings of the device using the verified second key.

8. The non-transitory computer-readable medium of claim 7, wherein booting the device further comprises:
based at least in part on verifying the third key of the BIOS, (i) downloading the operating system image, and (ii) verifying, using the verified third key, a fourth key that accompanies the operating system image.

9. The non-transitory computer-readable medium of claim 8, wherein booting the device further comprises:
verifying, using the verified fourth key, a signature of the operating system image that accompanies the operating system image.

10. The non-transitory computer-readable medium of claim 1, wherein the key is hardcoded within the hardware component of the device, such that subsequent to the key being hardcoded, the key cannot be changed without damaging the hardware component.

11. The non-transitory computer-readable medium of claim 1, wherein the hardware component comprises a plurality of fuses of the device that can be written or programmed only once.

12. The non-transitory computer-readable medium of claim 1, wherein the source code is for deployment to a plurality of mobile devices.

13. The non-transitory computer-readable medium of claim 1, wherein the device is a small-form-factor device that (i) has no operational Universal Serial Bus (USB) port and/or no wireless connectivity capability, or (ii) has an USB port and/or wireless connectivity capability disabled through BIOS (basic input/output system) settings of the device.

14. The non-transitory computer-readable medium of claim 1, wherein the operations further include:
causing to at least temporarily store the analysis result in the device.

15. A method comprising:
booting a device, wherein booting the device comprises (i) causing to verify key hardcoded within a hardware component of the device, (ii) downloading an operating system image, and (iii) loading the operating system image in the device;
analyzing, by the device, a source code stored in a customer tenancy of a cloud environment;
causing to store an analysis result in the customer tenancy of the cloud environment, where the analysis result includes one or more snippets of the source code; and
causing extraction of the analysis result from the customer tenancy of the cloud environment to a service tenancy of the cloud environment.

16. The method of claim 15, further comprising:
accessing a plurality of BIOS (basic input/output system) settings of the device;
selecting a subset of the BIOS settings; and
comparing the selected subset of the BIOS settings with a plurality of target BIOS settings.

17. The method of claim 16, further comprising:
detecting a mismatch between the selected subset of the BIOS settings and the plurality of target BIOS settings; and
in response to the detected mismatch, (i) causing to present information indicative of the detected mismatch at a user interface, and (ii) flagging the device as a risk and causing to undertake protective actions against the device.

18. The method of claim 15, wherein booting the device further comprises:
based at least in part on verifying the unalterable key hardcoded within the hardware component of the device, verifying a second key of BIOS (basic input/output system) settings of the device using the unalterable key;
based at least in part on verifying the second key of BIOS (basic input/output system) settings of the device, verifying a third key of BIOS (basic input/output system) settings of the device using the verified second key;
based at least in part on verifying the third key of the BIOS, (i) downloading the operating system image, and (ii) verifying, using the verified third key, a fourth key that accompanies the operating system image; and
verifying, using the verified fourth key, a signature of the operating system image that accompanies the operating system image.

19. A system comprising:
one or more processors; and
one or more non-transitory computer-readable media storing instructions, which, when executed by the system, cause the system to perform a set of actions including:
booting a device, wherein booting the device comprises (i) causing to verify a key hardcoded within a hardware component of the device, (ii) downloading an operating system image, and (iii) loading the operating system image;
analyzing a source code stored in a customer tenancy of a cloud environment;
causing to store an analysis result in the customer tenancy of the cloud environment, where the analysis result includes one or more snippets of the source code; and
causing extraction of the analysis result from the customer tenancy of the cloud environment to a service tenancy of the cloud environment.

20. The system of claim 19, wherein the actions further include:
accessing a plurality of BIOS (basic input/output system) settings of the device;
selecting a subset of the BIOS settings; and
comparing the selected subset of the BIOS settings with a plurality of target BIOS settings.
